(19) United States
(12) Patent Application Publication
(10) Pub. No.: US 2012/0255650 A1
(43) Pub. Date: Oct. 11, 2012

(54) LOG SPLITTER APPARATUS AND RELATED METHODS

(75) Inventor: Robert Fields, Longville, MN (US)

(73) Assignee: EFAB LLC, Longville, MN (US)

(21) Appl. No.: 13/080,744

(22) Filed: Apr. 6, 2011

(51) Int. Cl. B27L 7/00; B27G 21/00

(52) U.S. Cl. 144/366; 83/860; 144/193.1

(57) ABSTRACT

A guard for a log splitter apparatus is disclosed herein. In various aspects, the guard includes a support member adapted to be secured to a rail of a log splitter apparatus, and a panel hingedly secured to the support member. The panel may be lockably positionable at least between a collapsed position and an extended position. The panel is adapted to capture at least portions of a log, in various aspects. In various aspects, a plurality of support members are located about the panel to secure the panel to the rail of the log splitter apparatus. The support members may be located such that the support members and the panel avoid interference with mechanisms of the log splitter apparatus with the guard secured to the rail. This Abstract is presented to meet requirements of 37 C.F.R. §1.72(b) only. This Abstract is not intended to identify key elements of the apparatus and methods disclosed herein or to delineate the scope thereof.

### BACKGROUND OF THE INVENTION

1. Field

The present disclosure relates to log splitter apparatus, and more specifically, equipment adapted to capture logs or chunks of logs ejected from the log splitter apparatus.

2. Background

Log splitter apparatus are widely used to split logs for use as firewood. However, log splitting using a log splitter apparatus can be a dangerous activity, because chunks of wood may fall off of the log splitter apparatus and strike the user for example, on the legs and feet. A log may suddenly disintegrate while being split showering splinters of wood over the area. Furthermore, the user may find it difficult to pick up repeatedly chunks of wood that have fallen off of the log splitter apparatus, for example, onto the ground, as this requires bending over and lifting the chunk of wood from the ground for further processing such as additional splitting into smaller pieces, loading into a trailer, or placement onto a storage rack.

It may be desirable to move the log splitter apparatus to areas where wood is being cut, to areas where wood is being stored, or both, and the log splitter apparatus may be stored for long periods of time between uses.

Accordingly, there is a need for improved apparatus as well as related methods that may capture chunks of wood from the log splitter apparatus while not impeding the transport or storage of the log splitter apparatus.

### BRIEF SUMMARY OF THE INVENTION

These and other needs and disadvantages may be overcome by the apparatus and associated methods disclosed herein. Additional improvements and advantages may be recognized by those of ordinary skill in the art upon study of the present disclosure.

A guard for a log splitter apparatus is disclosed herein. In various aspects, the guard includes a support member adapted to be secured to a rail of a log splitter apparatus, and a panel hingedly secured to the support member. The panel may be lockably positionable at least between a collapsed position and an extended position. The panel is adapted to capture at least portions of a log, in various aspects. In various aspects, a plurality of support members are located about the panel to secure the panel to the rail of the log splitter apparatus. The support members may be located such that, with the guard secured to the rail, the support members and the panel avoid interference with mechanisms of the log splitter apparatus.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by perspective view an implementation of a log splitter apparatus with panels in the extended position;

FIG. 1B illustrates by perspective view the implementation of the log splitter apparatus of FIG. 1A with panels in the collapsed position;

FIG. 2A illustrates by side view portions of the implementation of the log splitter apparatus of FIG. 1A;

FIG. 2B illustrates by top view the portions of the implementation of the log splitter apparatus of FIG. 2A;

FIG. 2C illustrates by side view portions of the implementation of the log splitter apparatus of FIG. 1A;

FIG. 2D illustrates by side cut-away view portions of the implementation of the log splitter apparatus of FIG. 1A;

FIG. 2E illustrates by side cut-away view portions of an implementation of a log splitter apparatus;

FIG. 3A illustrates by top view portions of an implementation of a log splitter apparatus;

FIG. 3B illustrates by side cut-away view portions of the implementation of the log splitter apparatus of FIG. 3A;

FIG. 3C illustrates by perspective view portions of the implementation of the log splitter apparatus of FIG. 3A;

FIG. 4 illustrates by side cut-away view portions of an implementation of a log splitter apparatus; and,

FIG. 5 illustrates by process flow chart an exemplary method of operation of an exemplary log splitter apparatus.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

A log splitter apparatus that includes a guard for the capture of ejected wood chunks is disclosed herein. In various aspects, the guard includes a panel hingedly attached to a support member. The support member may be secured to a rail portion of the log splitter apparatus to secure the guard to the log splitter apparatus. In various aspects, the guard including the panel and one or more support members is adapted for attachment to a variety of log splitters.

The panel may be hingedly positioned between at least a collapsed position and an extended position. Placement of the panel into the collapsed position may facilitate transport or storage of the log splitter apparatus. When placed in the extended position, the panel may capture at least portions of a log, for example, following splitting of the log. With the panel in the extended position, the user may rest a portion of a log upon the panel for eventual placement upon the splitter. A plurality of the support members may secure the panel to the rail of the log splitter apparatus, and the support members may be positionable about the log splitter apparatus to avoid interference with the mechanisms of the log splitter apparatus.

In some aspects, the panel may be generally planar. In other aspects, the panel may be curved to conform to the curvature of the log. For example, large forces may be developed within the log as the log is being split by the log splitter apparatus that may cause the log to burst into fragments that may fly about thereby posing a hazard to, for example, the lower extremities of a user of the log splitter apparatus. The panel, such as a panel having either a generally straight shape or a curved shape that generally conforms to the curved shape of the log, may be positioned to confine portions of the log while the log is being split, for example, in order to contain fragments of the log to prevent injury to the user. Two or more guards may be provided in various aspects and the guards may be positioned on opposite sides of the log splitter apparatus.

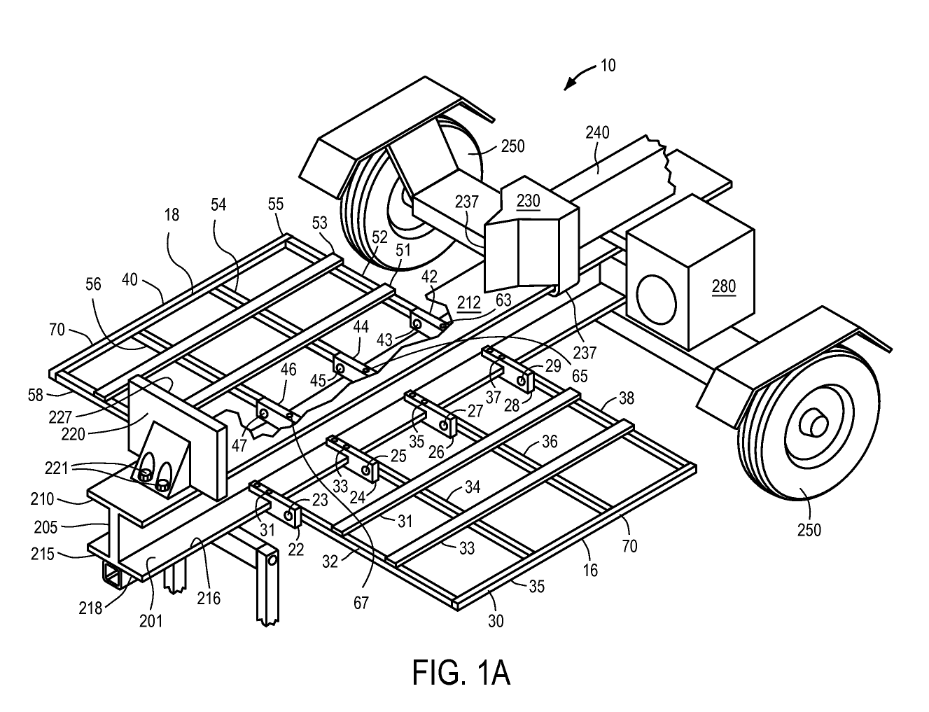

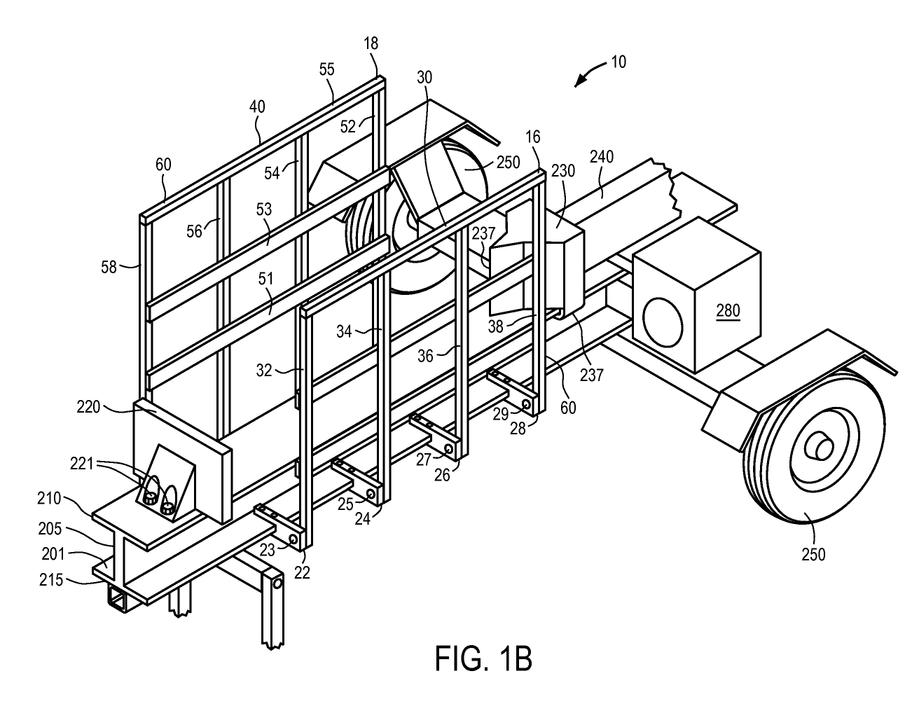

FIGS. 1A and 1B illustrate an implementation of a log splitter apparatus 10 including guards 16, 18 attached thereto. As illustrated in FIG. 1A, log splitter apparatus 10 includes rail 201 that is formed as an I-beam having webbing 205 interposed between flanges 210, 215. In other implementations, rail 201 may be a railroad rail, various other types of structural beams, or similar, and may be made, for example, of steel, iron, or aluminum.

Base 220 is secured about surface 212 of rail 201, as illustrated, and carriage 230 located on surface 212 of rail 201. Base 220, as illustrated, is fixed to rail 201 by bolts 221, but may be fixed to rail 201 by welds, by a combination of bolts and welds, or so forth, in various implementations.

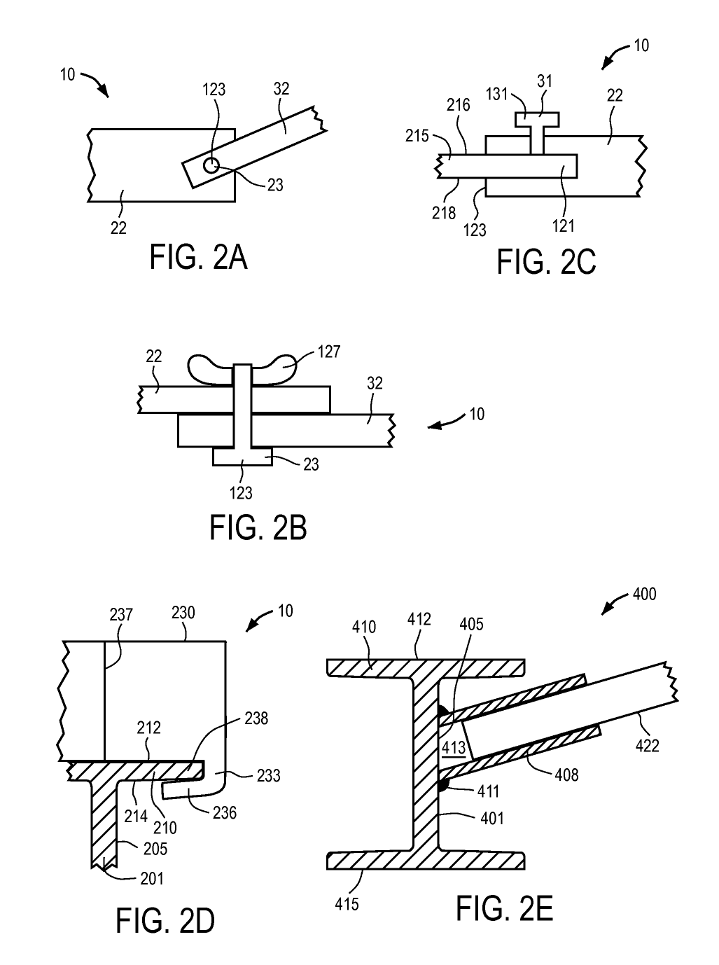

Carriage 230 is slidably secured to flange 210 of rail 201 at carriage attachment 233. In various implementations, carriage attachment 233 may be formed as a channel that receives portions of flange 210 so that flange 210 may slide through the channel 238 (see FIG. 2D) to allow carriage 230 to slide upon surface 212 of rail 201 and flange 210 while being secured to flange 210. Carriage attachment 233, in various implementations, may include various rollers, bearings and so forth to allow the carriage 230 to slide upon rail 201.

Carriage 230 is connected to shaft 240 and shaft 240 is actuated by a source of motivation such as a hydraulic actuator, pneumatic actuator, screw, or so forth, (not shown), and the source of motivation may be connected to a power source 280 such as a gasoline engine, electric motor or suchlike, as would be readily recognized by those of ordinary skill in the art upon review of this disclosure. The shaft 240, as actuated by the source of motivation, may direct carriage 230 to traverse the rail 201 toward base 220 or away from base 220. Various controls (not shown) may be provided to allow the user to control the traversal of the carriage 230 toward or away from base 220 or to hold carriage 230 in a particular location on rail 201.

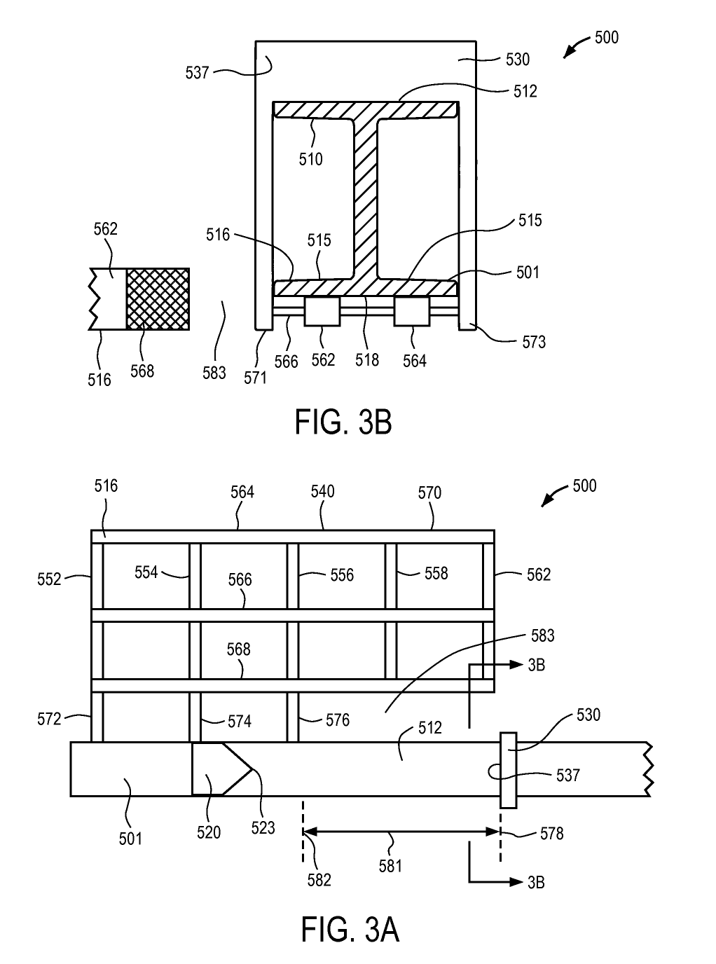

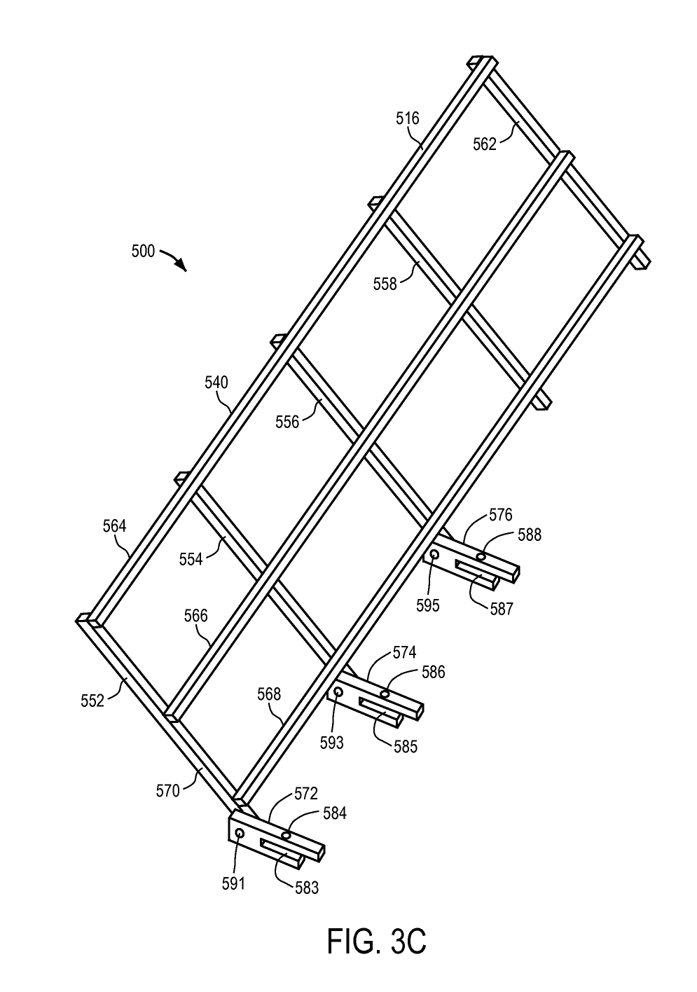

In the implementation of the log splitter apparatus 10 illustrated in FIGS. 1A and 1B, the carriage 230, which is movable, is formed as a wedge 237, and base 220, which is fixed, is formed to have a generally flat face 227 oriented toward wedge 237 of carriage 230 along rail 201. In other implementations (see FIG. 3A), the fixed base, such as base 220, may be formed as a wedge, such as wedge 237, and the movable carriage, such as carriage 230, may be formed to have a generally flat face, such as face 227, with the wedge portion of the base and the flat face portion of the carriage oriented toward one another along rail 201.

As illustrated in FIG. 1A, guards 16, 18 are secured to flange 215 of rail 201 opposite one another along rail 201, and panels 30, 40 of guards 16, 18, respectively, are positioned in the extended position 70. Guards 16, 18 as illustrated in FIGS. 1A and 1B, are generally secured about the portion of rail 201 traversed by carriage 230 such that, when panels 30, 40 are positioned in the extended position 70, panels 30, 40 capture logs or portions of logs that roll off of surface 212 of rail 201 or portions of the log that may fall off of surface 212 following the splitting of the log upon surface 212 of rail 201. Guards 16, 18 are secured to lower flange 215 of rail 201, as illustrated, and carriage 230 traverses upper surface 212 of rail 201 and upper flange 210, so that the guards 16, 18 in the extended position 70 do not interfere with the traversal of carriage 230.

Panel 30 of guard 16 is formed from members 31, 32, 33, 34, 35, 36, 38 that are secured to one another to form a lattice structure, as illustrated in FIG. 1A. Members 32, 34, 36, 38 are hingedly attached to support members 22, 24, 26, 28, respectively, at hinges 23, 25, 27, 29 (see FIGS. 2A & 2B) and support members 22, 24, 26, 28 are secured to flange 215 of rail 201 by connectors 31, 33, 35, 37 (see FIG. 2C) in this implementation. Accordingly, panel 30 is positionable about hinges 23, 25, 27, 29 between extended position 70 illustrated in FIG. 1A, and collapsed position 60 illustrated in FIG. 1B. After being placed in the extended position 70 or in the collapsed position 60 or in positions intermediate of the extended position 70 and the collapsed position 60, panel 30 may be locked in the extended position 70, the collapsed position 60, or in positions intermediate of the extended position 70 and the collapsed position 60. Panel 30 may be unlocked and then rotated about hinges 23, 25, 27, 29 into a new position. For example, panel 30 may be unlocked and then rotated about hinges 23, 25, 27, 29 from the collapsed position 60 into the extended position 70 and then locked at the extended position so that no further rotation of panel 30 occurs without unlocking hinges 23, 25, 27, 29.

Panel 40 is formed similarly to panel 30 and includes members 51, 52, 53, 54, 55, 56, 58 secured to one another to form a lattice structure, as illustrated in FIG. 1A. Members 52, 54, 56 are hingedly attached to support members 42, 44, 46 at hinges 43, 45, 47, and support members 42, 44, 46 are secured to flange 215 of rail 201 by connectors 63, 65, 67, respectively. Although not shown in FIG. 1A, member 58 is hingedly attached to a support member, such as support member 22, 24, 26, 28, 42, 44, 46, and the support member is secured to flange 215 by a connector, such as connector 31, 33, 35, 37, 63, 65, 67. Accordingly, panel 40 is positionable about hinges 42, 44, 46, and the hinge connection of member 58 between extended position 70 illustrated in FIG. 1A, and collapsed position 60 illustrated in FIG. 1B. Panel 40 may be locked in the extended position 70, the collapsed position 60, or in positions intermediate of the extended position 70 and the collapsed position 60.

FIG. 1B illustrates panels 30, 40 in collapsed position 60 in which the panels 30, 40 are generally oriented vertically. In this implementation, when placed in the collapsed position, panels 30, 40 extend generally vertically above rail 201, but may be hinged to extend downward generally vertically below rail 201 in other implementations. As illustrated in FIGS. 1A and 1B, log splitter apparatus 10 includes wheels 250 to allow the log-splitter 10 to be moved about. In various implementations, the log splitter apparatus 10 may include a trailer hitch or other such towing connection (not shown) to allow the log splitter apparatus to be moved about by towing. Positioning of panels 30, 40 of guards 16, 18 in the collapsed position 60 may reduce the width of the log splitter apparatus 10, which may facilitate the moving about of the log splitter apparatus 10. Positioning of panels 30, 40 of guards 16, 18 in the collapsed position 60 may reduce the horizontal space occupied by the log splitter apparatus 10, which may facilitate storage of the log splitter apparatus 10.

FIGS. 2A & 2B illustrate hinge 23 that connects member 32 to support member 22. Hinges 25, 27, 29, 43, 45, 47 that connect members 34, 36, 38, 52, 54, 56 to support members 24, 26, 28, 42, 44, 46, respectively, may be generally similar to hinge 23 that connects member 32 to support member 22 in this illustration. As illustrated in FIGS. 2A & 2B, member 32 is attached to support member 22 by hinge 23 that is formed as a pin 123 so that member 32 may rotate about pin 123, and, thus, member 32 may rotate about support member 22. Pin 123 may be a bolt or similar connector that passes through member 32 and support member 22. Member 32 and support member 22 are secured to one another by pin 123 in combination with nut 127, which may be a wing-nut (as illustrated), standard hexagonal nut, or similar threaded attachment, in this implementation. Various washers and so forth may be included in various implementations, and other hinged fasteners may be used in other implementations to attach member 32 to support member 22. Hinge 23 may be unlocked or locked by loosening or tightening, respectively, nut 127, in this implementation. For example, member 32 may be placed in a desired position and the nut 127 tightened to lock frictionally member 32 in the desired position. Nut 127 may be loosened to unlock hinge 23 by allowing hinged movement of member 32 relative to support member 22. In various implementations, pin 123 and nut 127 may be removed to disengage member 32 from support member 22. Other hinges that allow rotation of member 23 about support member 22 and that allow for locking member 32 into position with respect to support member 22 may be used in other implementations. Other hinges that for disengagement of member 32 from support member 22 may be used in other implementations.

FIG. 2C illustrates the attachment of support member 22 to flange 215. Support members 24, 26, 28, 42, 44, 46 may be attached to flange 215 in a manner similar to the attachment of support member 22 to flange 215 illustrated in FIG. 2C. As illustrated in FIG. 2C, slot 121 is formed in end 123 of support member 22 and slot 121 receives portions of flange 215 therein. In this implementation, bolt 131 passes through portions of support member 22 into slot 121 to engage flange 215 within slot 121 in order to secure support member 22 to flange 215. As illustrated in FIG. 2C, bolt 131 frictionally engages flange 215 when tightened to secure support member 22 to flange 215. In other implementations, for example, bolt 131 may threadedly engage flange 215, may pass through flange 215 through a hole provided through the flange and be threadedly engaged with opposing portions of support member 22, with various nuts or other threaded fasteners, or combinations thereof.

Support member 22 is removably secured to flange 215 as the support member 22 may be disengaged from flange 215 by disengagement of bolt 131 from flange 215. In other implementations (not shown), support member 22 may be secured to rail 201 including flange 215 permanently (non-removably) by weld or other such attachment.

FIG. 2D illustrates carriage attachment 233 of carriage 230, which is formed, in part, by arm 236. A channel 238 is defined by arm 236 of carriage attachment 230. A portion of flange 210 of rail 201 is received in channel 233 so that portions of flange 210 may slide within channel 238. Portions of arm 236 then slide upon surface 214 of flange 210 and portions of carriage 230 may slide upon surface 212 of rail 201. Bearings, rollers, and so forth may be provided within channel 238 or otherwise located about carriage 230 including arm 236 to facilitate movement of carriage 230 along rail 201. Another carriage attachment (not shown) similar to carriage attachment 230 may be provided on the opposite side of rail 201 to guide the carriage along the rail 201.

FIG. 2E illustrates an implementation of log splitter apparatus 400. As illustrated in FIG. 2D, hanger 408 is secured to web 405 of rail 401 between flange 405 and flange 415 in log splitter apparatus 400. Hanger 408, as illustrated, is secured to web 405 by weld 411. Hanger 408 in this implementation is positioned on web 405 such that hanger 408 does not interfere with the traversal of the carriage, such as carriage 230. Hanger 408 defines interior cavity 413, and portions of support member 422 are received within cavity 413 by insertion therein. Portions of support member 422 may be attached within cavity 413 of hanger 408 by interference fit, as illustrated, or various bolts or other fasteners may be provided to attach support member 422 to hanger 408, or both, in various implementations.

Another implementation of log splitter apparatus 500 is illustrated in FIGS. 3A, 3B, and 3C. As illustrated in FIG. 3A, base 520 and carriage 530 are mounted upon surface 512 of rail 501. Base 520 has a generally wedge shaped face 523 that is oriented toward the generally planar face 537 of carriage 530. Base 520 is fixed to rail 501 while carriage 530 may move along rail 501 along path 581, for example, to compress a log between face 537 of carriage 530 and face 523 of base 520 thereby splitting the log. Guard 516, which includes panel 540, is removably secured to rail 501 and positioned in extended position 570 to capture logs or pieces of logs that may fall off of surface 512 of rail 501 during operation of log splitter apparatus 500. Another guard similar to guard 516 may be positioned along rail 501 but this additional guard is omitted from these illustrations for purposes of illustrative clarity.

As illustrated in FIG. 3A, panel 540 of guard 516 is formed of members 564, 566, 568, 552, 554, 556, 558, 562 secured to one another in a lattice structure. Members 552, 554, 556 of panel 540 are hingedly attached (see FIG. 3C) to support members 572, 574, 576, respectively, and support members 572, 574, 576 are removably attached to flange 515 of rail 501 to secure guard 516 to rail 501. Members 558 and 562, although generally parallel to members 552, 554, 556, are not attached to rail 501 so that portions of the panel 540 including members 558, 562 are cantilevered from member 556 and support member 576, as illustrated. In this implementation, panel 540 of guard 516 extends alongside rail 501 along path 581 such that member 568 is set apart from rail 501 to define gap 583 between the portion of member 568 that generally extends between support member 576 and member 562 and rail 501. Portions of the carriage 530 may pass within gap 583 without the carriage 530 contacting member 562 of panel 540 as the carriage 530 is traversed along path 581 between path endpoints 578, 582, while any log or pieces of log that fall off of surface 512 of rail 501 may fall upon panel 540. For example, as illustrated in FIG. 3A, arm 571 of carriage 530 may pass through gap 583 between member 568 and rail 501 as carriage 530 is traversed along path 581. Thus, guard 516 is mounted to rail 501 in such a way that guard 516 does not interfere with the traversal of carriage 530, and, hence, guard 516 does not interfere with the operation of log splitter 500.

A detail of carriage 530 is shown in FIG. 3B. As illustrated in FIG. 3B, carriage 530 rests along surface 512 of flange 510 of rail 501. Arms 571, 573 of carriage 530 extend past flange 515 of rail 501. Axle 566 passes between arms 571, 573 such that rollers 562, 564 that are secured to axle 566 pass along surface 518 of flange 515 of rail 501. Thus, when carriage 530 is traversed along path 581, portions of carriage 530 slide upon surface 512 and wheels 562, 564 roll upon surface 518 of rail 501. Thus, even though, in this implementation, the traversal of carriage 530 along path 581 implicates both flanges 510, 515 of rail 501, guard 516 is mounted to rail 501 in such a way that guard 516 does not interfere with the traversal of carriage 530 along path 581.

FIG. 3C illustrates log splitter apparatus including guard 516, which includes panel 540. As illustrated in FIG. 3C, members 552, 554, 556 of panel 540 are hingedly attached to support members 572, 574, 576 by hinges 591, 593, 595, respectively, so that panel 540 may be positioned between an extended position 570, as illustrated, and a collapsed position (not shown). Hinges 591, 593, 595 may, for example, be formed in the same way as hinge 23 that attaches member 32 to support member 22 illustrated in FIGS. 2A & 2B. Support members 572, 574, 576 may be attached to flange 515 of rail 501 to secure panel 540 to rail 501 in a manner similar to the attachment of support member 22 to flange 215 illustrated in FIG. 2C. As illustrated in FIG. 3C, slots 583, 585, 587 are formed in support members 572, 574, 576, respectively, and portions of flange 515 may be received in slots 583, 585, 587. In this implementation, bolts 584, 586, 588 pass through portions of support members 572, 574, 576 into slots 583, 585, 587, respectively, to engage flange 515 within slots 583, 585, 587 in order to attach in a removable fashion the support members 572, 574, 576 to flange 515. Support members 572, 574, 576 are attached to flange 515 of rail 501 at locations such that support members 572, 574, 576 do not interfere with carriage 530 as carriage 530 traverses path 581.

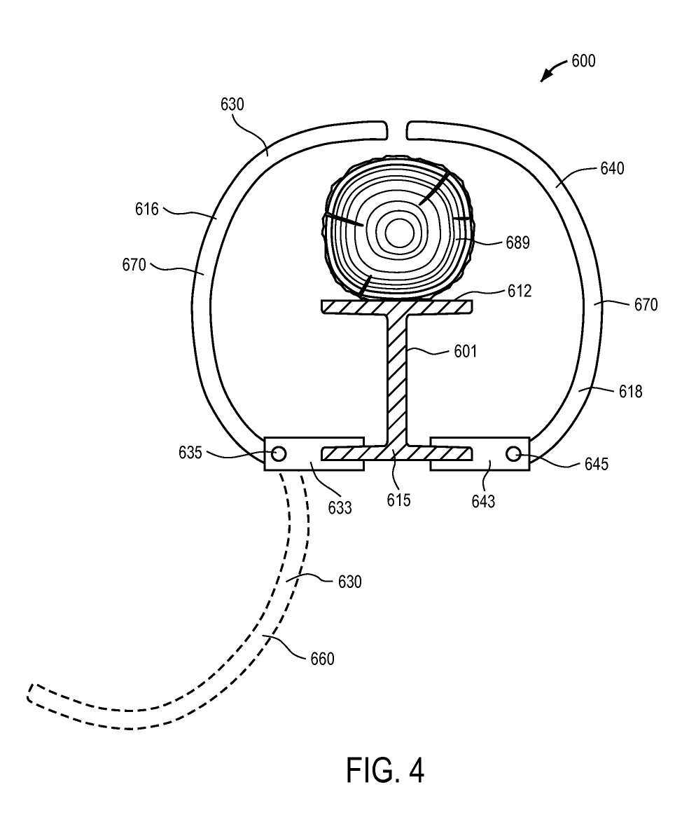

FIG. 4 illustrates log splitter apparatus 600 that includes rail 601 and panels 630, 640, of guards 616, 618, respectively. Panel 630 of guard 616 is hingedly attached to support member 633 by hinge 635, and support member 633 is removably attached to flange 615 of rail 601. Panel 640 is hingedly attached to support member 643 by hinge 645, and support member 643 is removably attached to flange 615 of rail 601. Hinges 635, 645 may be generally configured as hinge 23, as illustrated in FIGS. 2A and 2B, in various implementations. Support members 633, 643 may be formed similarly to support member 22, and support members 633, 643 may be attached to flange 615 in a manner similar to the attachment of support member 22 to flange 215, as illustrated in FIG. 2C. Panels 630, 640 are curved such that, when placed in the extended position 670, panels 630, 640 surround log 689 to protect the user by containing fragments of log 689 should log 689 shatter while being split. In FIG. 4, panel 630 of guard 616 in the collapsed position 660 is illustrated in phantom. Panel 630 may be positioned between the collapsed position 660 and the extended position 670 by rotation about hinge 635. In the collapsed position 660, panel 630 extends generally downward from rail 601 and may allow the user to access rail 601, for example, to place log 689 thereupon. Panels 640, 640 may be rotated into the collapsed position 660 during transport or storage of log splitter apparatus 600.

In operation of the log splitter apparatus, such as log splitter apparatus 10, 400, 500, 600, panels, such as panels 30, 40, 540, 630, 640, of guards, such as guards 16, 18, 516, 616,618, may be positioned in the extended position, such as extended position 70, 570, 670. A log, such as log 689, may be placed upon surface, such as surface 212, 412, 512, 612, of the rail, such as rail 201, 401, 501, 601, of the log splitter apparatus. The log is positioned such that the ends of the log are generally oriented toward the base, such as base 220, 520, and the carriage, such as carriage 230, 530. The carriage is then activated such that the carriage traverses along a path, such as path 581, toward the base to compress the log between the carriage and the base in order to split the log. Should the log fall off of the surface while being positioned upon the surface, the log may fall upon the panel of the guard, which then captures the log and prevents the log from falling away from the log splitter apparatus. The user may reposition the log from the guard back onto the surface in order to continue splitting of the log. Similarly, upon splitting of the log, any fragments of the log that fall off of the surface may then fall upon the guard(s), which then capture these fragments. Following splitting of the log, the user may retrieve the fragments of the log from the guard(s), from the surface of the rail, or both. The guard(s) may protect the user by, for example, preventing the log, fragments of the log, or both from falling upon the user's feet or legs or other lower portions of the user's body. In various aspects, the guard(s) may prevent splinters or other fragments of a log that explodes under compression from striking the user. The guard(s) may be positioned at a generally convenient height that facilitates the retrieval of the log or fragments of the log by the user, in various aspects.

When operation of the log splitter apparatus is completed, the panels of the guards may be positioned into the collapsed position, such as collapsed position 60, 560, 660, and the log splitter apparatus transported or stored with the panels in the collapsed position. The guards may be removed from the log splitter apparatus, for example, during transport or storage.

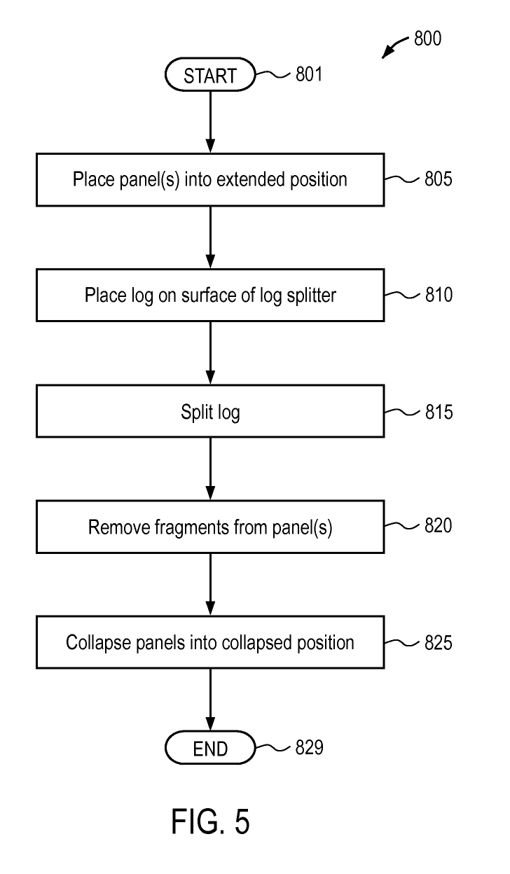

An exemplary operational method 800 is illustrated by process flow chart in FIG. 5. As illustrated in FIG. 5, method 800 is entered at step 801. At step 805, the panel(s) of the guard(s) are positioned into the extended position and locked in the extended position. At step 810, a log is placed upon the surface of the log splitter apparatus. At step 815, the log splitter apparatus is activated to split the log. At step 820, fragments of the log are removed from the panel(s) or other portions of the guard(s), from the surface, or from both the panel(s) or other portions of the guard(s) and the surface. At step 825, the panels are collapsed into the collapsed position and locked in the collapsed position. Method 800 is exited at step 829. In various aspects, operational methods may include installation of the guard(s) onto the rail. In various aspects, operational methods may include removal of the guard(s) from the rail. In various aspects, operational methods may include installation of support member(s), such as support members 22, 24, 26, 28, 42, 44, 46, 422, 572, 574, 576, 633, 643, onto the rail, removal of the support member(s) from the rail, or both. In some aspects, operational methods may include installation of hanger(s), such as hanger 408, onto the rail, with the hanger(s) adapted to secure the support member(s) to the rail. In various aspects, operational methods may include installing support member(s) to rail in such a way that the support member(s) do not conflict with the carriage as the carriage traverses the path.

The foregoing discussion along with the Figures discloses and describes various exemplary implementations. These implementations are not meant to limit the scope of coverage, but, instead, to assist in understanding the context of the language used in this specification and in the claims. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A guard for a log splitter apparatus, comprising:
a support member adapted to be secured to a rail of a log splitter apparatus;
a panel hingedly secured to the support member, the panel lockably positionable at least between a collapsed position and an extended position, the panel adapted to capture at least portions of a log.

2. The apparatus, as in claim 1, further comprising:
a plurality of the support members disposed about the panel to secure the panel to the rail of the log splitter apparatus while avoiding interference with mechanisms of the log splitter apparatus.

3. The apparatus, as in claim 1, wherein the panel is generally planar.

4. The apparatus, as in claim 1, wherein the panel is curved to conform generally to curved portions of a log.

5. The apparatus, as in claim 1, wherein the support member is adapted to be removably secured to the rail of the log splitter apparatus.

6. A log splitter apparatus, comprising:
a rail with an upper flange and a lower flange;
a carriage that traverses the rail along a path between a starting position and an ending position, portions of the carriage adapted to engage a log;
a base immovably engaged with the rail, portions of the base adapted to engage the log;
support members secured to the rail, the support members positioned to avoid the carriage as the carriage traverses between the starting position and the ending position;
a panel hingedly secured to the support members to be lockably positionable at least between a collapsed position and an extended position, the panel positioned adjacent the path and disposed to avoid the carriage as the carriage traverses the path between the starting position and the ending position.

7. The apparatus, as in claim 6, wherein the support members are secured to the lower flange of the rail.

8. The apparatus, as in claim 6, wherein the panel is generally planar.

9. The apparatus, as in claim 6, wherein the panel is curved to conform generally to curved portions of a log.

10. The apparatus, as in claim 6, wherein the support members are removably secured to the rail of the log splitter apparatus.

11. The apparatus, as in claim 6, wherein the support members are removably secured to the lower flange of the rail.

12. A method of splitting a log, comprising the steps of:
placing a panel into an extended position, the panel secured to a rail of a log splitter apparatus;
placing a log on a surface of the log splitter apparatus;
splitting the log using the log splitter apparatus; and
removing fragments of the log from the panel.

13. The method, as in claim 12, further comprising the step of:
placing the panel into a collapsed position following the step of removing fragments of the log from the panel.

14. The method, as in claim 12, further comprising the step of:
traversing portions of a carriage within a gap between the rail and the panel.
